(19) United States
(12) Patent Application Publication
(10) Pub. No.: US 2024/0028417 A1
(43) Pub. Date: Jan. 25, 2024

(54) EXECUTING FEDERATED WORKFLOWS FROM EDGE TO CORE

(71) Applicant: HEWLETT PACKARD ENTERPRISE DEVELOPMENT LP, Houston, TX (US)

(72) Inventors: SATHYANARAYANAN MANAMOHAN, Bangalore (IN); SATISH KUMAR MOPUR, Bangalore (IN); KRISHNAPRASAD LINGADAHALLI SHASTRY, Bangalore (IN); RAVI SARVESWARA, Bangalore (IN)

(21) Appl. No.: 17/868,587

(22) Filed: Jul. 19, 2022

(51) Int. Cl. G06F 9/50; H04L 9/00; G06F 9/455

(52) U.S. Cl. CPC G06F 9/5077; H04L 9/50; G06F 9/45558; G06N 20/20

(57) ABSTRACT

Systems and methods provide for a federated workflow solution to orchestrate entire machine learning (ML) workflows comprising multiple tasks, across silos. In other words, one or more sets/pluralities of tasks making up an ML workflow, can be executed across multiple resource partitions or domains. Federated workflow state can be maintained and shared through some form of distributed database/ledger, such as a blockchain. Agents that are locally deployed locally at the silos may orchestrate an ML workflow at a particular resource domains, each such agent having access, via the blockchain (acting as a globally visible/consistent state store), to the aforementioned workflow state. Such systems are capable of operating regardless of the existence of heterogeneous resources/aspects of a silo.

### BACKGROUND

Machine learning (ML) can refer to a method of data analysis in which the building of an analytical model is automated. ML is commonly considered to be a branch of artificial intelligence (AI), where systems are configured and allowed to learn from gathered data. Such systems can identify patterns and/or make decisions with little to no human intervention. Federated ML or federated/collaborative learning can refer to machine learning, where an algorithm is trained across multiple devices (e.g., edge computing devices) or servers using data or data samples local to those devices/servers.

Blockchain is one embodiment of a tamper-proof, decentralized ledger that establishes a level of trust for the exchange of value without the use of intermediaries. A blockchain can be used to record and provide proof of any transaction on the blockchain, and is updated every time a transaction occurs.

### BRIEF DESCRIPTION OF THE DRAWINGS

The technology disclosed herein, in accordance with one or more embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof.

FIG. 1A illustrates an example of a federated ML workflow that may be executed by examples of the disclosed technology.

FIG. 1B illustrates an example of a blockchain network in accordance with one example of the disclosed technology.

FIG. 1C illustrates an example of an node in a distributed blockchain network for federated ML workflow orchestration in accordance with one example of the disclosed technology.

FIG. 1D illustrates an example of a blockchain interface layer for federated ML workflow orchestration in accordance with one example of the disclosed technology.

FIG. 2A illustrates an example resource pool and partitioning in accordance with one example of the disclosed technology.

FIG. 2B illustrates example resource domains used in one example of the disclosed technology.

FIG. 2C illustrates an example federated ML workflow framework in accordance with one example of the disclosed technology

FIG. 3 is an example computing component that may be used to implement various functions of a federated ML workflow design component in accordance with one example of the disclosed technology.

FIG. 4 is an example computing component that may be used to implement various features of embodiments of the present disclosure.

The figures are not intended to be exhaustive or to limit embodiments to the precise form disclosed. It should be understood that the invention can be practiced with modification and alteration, and that the disclosed technology be limited only by the claims and the equivalents thereof.

### DETAILED DESCRIPTION

ML algorithms can refer to procedures implemented in software code, and that run on data to create an ML model(s). ML models can refer to the outputs of ML algorithms, and may comprise parameters that are automatically tuned by the ML algorithms using data as input, and a prediction algorithm (or process/procedure for using the data to make some prediction). In other words, an ML model represents what was learned by an ML algorithm. Thus, ML algorithms can provide, e.g., automated/automatic programming, where the ML models output from the ML algorithms represent the program. Good quality ML models can be key to achieving results that translate into business success. In turn, good quality ML models require training, and thus, the availability of diverse data and large quantity(ies) of data for training are also key. Due to concerns regarding data privacy and protection, data silos are often created to store/maintain data, such as training data. Data silos can refer to independent sets of data within some enterprise or other organization, access to which is typically limited.

Federated learning techniques can be used with siloed data, e.g., a local ML model can be trained with data local to the node hosting the ML model. Thus, if training is considered one aspect or phase of ML, federated learning techniques can facilitate executing that training phase in a distributed environment, where each node controls or manages the task(s) making up the training phase locally. However, federated learning techniques only address one phase, i.e., the training phase, of an overall ML workflow/set of ML workflows or phases that make up, e.g., an ML project. Thus, to supplement federated learning techniques that operate across data silos, examples of the disclosed technologies comprise systems and methods for a federated workflow solution to orchestrate entire ML workflows comprising multiple tasks, across silos. That is, one or more sets/pluralities of tasks can be executed across multiple resource partitions or domains. In this way, federated learning can made to be a more practical solution for businesses. Silos, as will be described in greater detail below, may refer to some resource partition, be it a data resource(s) (i.e., data silo), a compute resource(s), or both. Silos may arise, again due to limiting access to data, but can also arise due to the heterogeneity of resources used to perform operations thereon. For example, in the context of ML, a silo may arise as a result of the deep learning framework used, e.g., Keras, Tensorflow, PyTorch, etc., a silo may arise due to the type of hardware used (CPU-based versus GPU-based hardware), the type of orchestrator used, and so on. This is because such characteristics prevent universal accessibility or use.

Technical improvements are realized throughout the disclosure. For example, the disclosed technologies implement systems and methods that allow for workflow state to be maintained, e.g., in some form of distributed database, such as a blockchain or other distributed ledger. Agents can be deployed locally at resource domains or collections of resources. Such agents may orchestrate an ML workflow at particular resource domains, each such agent having access, via the blockchain (acting as a globally visible/consistent state store), to the aforementioned workflow state. This provides the ability to work with/within a heterogenous environment. The use of such agents, in conjunction with (decentralized) states maintained in a distributed ledger (e.g., blockchain), results in the ability to eschew the need for a centralized controller. Because examples of the present disclosure eschew the use of a central controller or centralized state store, examples are fully decentralized with respect to control, architecturally federated, and can operate regardless of the heterogeneity/heterogeneous implementation(s) existing in a silo. Such frameworks can become the backbone of next generation ML applications in various contexts, e.g., healthcare and finance, where business advantages are derived from collaboration between entities (which can amount to cross-resource domain orchestration). Examples of the disclosed technologies comprise a complete framework for designing, deploying, and executing federated ML workflows, the framework capable of spanning a network from edge to core, being easy-to-use, multi-sited, and decentralized.

Although tools and technologies exist for performing ML workflow orchestration, conventional/known tools and technologies are non-federated workflow technologies. In contrast to the disclosed examples herein, such non-federated workflow technologies are centrally controlled, where workflows are managed within their respective local resource domains (as alluded to above). KubeFlow® for example, depends on K8s (also referred to as Kubernetes) to deploy workflows. K8s depends on a centralized, single instance “state” database stored in “etcd.” K8s manager(s) will have to be authorized and given access to such a state database for any of its operations. Currently, there are no federated solutions that allow K8s managers to combine multiple instances of this state database into a federated framework. Consequently, Kubeflow® cannot be federated due to its underlying dependency on K8s. Such centralized ML workflow orchestration can result in an architectural bottleneck without an easy workaround, and further translates into scaling and single point of failure problems for such systems. In edge-computing scenarios, intermittent connectivity issues to a centralized state store can make managing the edge of a network difficult as compared to a federated workflow solution, in which a localized controller can manage its edge effectively. In a multi-organizational scenario, where resource domains may comprise organizational-specific/proprietary resources, data, or intelligence, managing workflows across multiple resource domains would be a complex endeavor due to such non-uniformity.

It should be understood that as used herein, the term “workflow” can refer to a set or sequence of tasks or jobs that runs in an ML process, and correlates to different phases of an ML project. In other words, a workflow can comprise a series of related tasks that accomplish some goal, like a business goal. The phases may include, e.g., data collection, data pre-processing, building datasets, model training and refinement, validation/evaluation, and operationalization (or simply deployment to production system. Pipelines can refer to some infrastructure medium/media for an overall ML workflow, and that can assist in automating the overall ML workflow (e.g., beginning with data collection through ML model deployment. Post-deployment, pipelines can also support reproduction, tracking, and monitoring of an ML workflow(s). Orchestration in the ML sense, can refer to the automation or management of a workflow or multiple tasks/jobs of a workflow, as well as the pipeline.

Examples of the disclosed technologies include a plurality of resource partitions or domains, e.g., collections of compute, storage, networking, and security resources under the control of a native resource manager such as the aforementioned K8s managers. Abstracting physical resources into a collective resource domain enables the federated workflow solution disclosed herein to isolate both resource allocation (to a workflow/phase/job/task) and security aspects into a locally administered sandbox. That is, the hardware provisioning aspect or dimension of the heterogeneity problem can be addressed. Similar to sandboxes that refer to some virtual machine or compute in which resources can be allocated accordingly and security operations can be performed/managed/monitored, examples may differentiate security of certain resources from others within a particular silo, e.g., changing access passwords. In the context of ML workflows, workflows can be executed entirely by a particular resource domain, or a workflow may span multiple resource domains, e.g., some subset of tasks of the workflow may be performed by a first resource domain, while some other subset of tasks of the same workflow may be performed by a second, different resource domain.

As noted above, tasks or jobs can make up an ML workflow, where tasks/jobs can refer to some logical unit of work (node) in an ML workflow. Each task or job may include metadata and a body. The metadata of a task or job can comprise information regarding the nature of the task, and may be represented as a YAML task definition. The nature of the task can be some characterization(s) including inputs to/outputs from the task, task dependencies, task outcomes, task constraints or requirements, communication channels used by tasks, etc. The “layout” of a workflow may also be a type of metadata making up a particular task or job. Task metadata may be stored in a distributed database, e.g., a blockchain, as noted above.

The body of a task or job may comprise the implementation (or code) of the task as well as any relevant artifacts. Task bodies can be maintained in a source code repository, e.g., for versioning and collaboration, e.g., GitHub, Docker Hub, etc.). In some examples, a task is encapsulated or packaged as a container or downloadable. It should be understood that ML workflow orchestration mechanisms or tools may operate using containers, e.g., a way of packaging code and allowing it to run on a computer/machine. Such code can, as alluded to above, require other code/software to operate, require certain system or operating system requirements (e.g., amount of memory) to run. A container may command its own runtime environment such as libraries, files, environment variables, etc. which can be used or installed on a computer/machine as needed. By using or leveraging containers to represent or embody tasks, the aforementioned heterogeneity can be abstracted into generic or common task definitions (with inputs/outputs). Here, examples of the disclosed technologies address the software dimension of the heterogeneity problem. Each concept, e.g., resource domain, task, agent is able to address/handle certain aspects of the heterogeneity problem. Moreover, such abstractions provide an end user with the ability to see an entire network in a uniform view, which translates to a powerful business advantage in the context of ML. Combining or chaining such containers results in the creation of workflows, e.g., ML workflows, which as described herein, can be run on a decentralized system or network of silos. An added advantage to leveraging containers is that proprietary software code can be shared for use without a need to expose the actual software code itself, enabling better/increased collaboration between entities.

While the tasks themselves have been genericized using containers, the underlying resources, e.g., physical compute or memory resources, of a silo have not, and so heterogeneity remains at the resource level. To address this heterogeneity, and allow ML workflows to be run across silos despite such resource heterogeneity, an agent, also referred to as a federated workflow executor runs with/in each resource domain. An agent may be some software/computer program that reacts to its environment and runs, typically, without continuous supervision to perform some function(s) for an end user or some other program. In this context, such agents operate to execute individual tasks of a workflow. Agents may communicate with various elements or components of the disclosed federated workflow framework, e.g., other agents running in other silos or resource domains, using control messaging on the blockchain. Agents maintain the state of the workflow, and abstract local resource access, identity, and authorization so that regardless of the resource heterogeneity, federated workflow can be achieved. That is, agents interface a task encapsulated in a container and the local resources of the resource domain. This allows the local resources to execute the task (which by virtue of being containerized, is translated into common task definitions that the agent knows how to execute using the local resources).

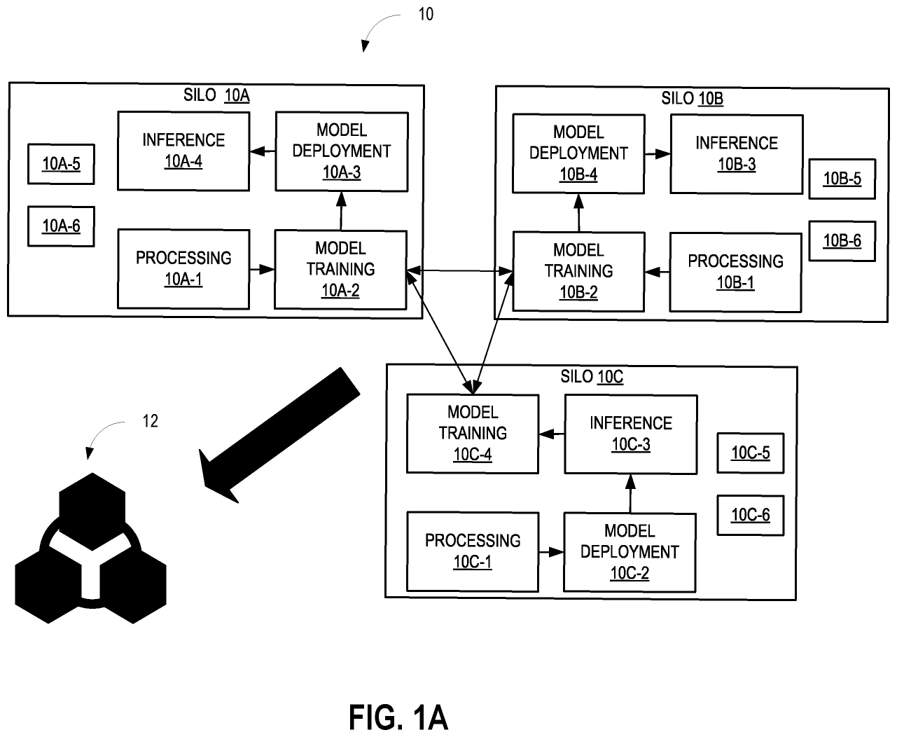

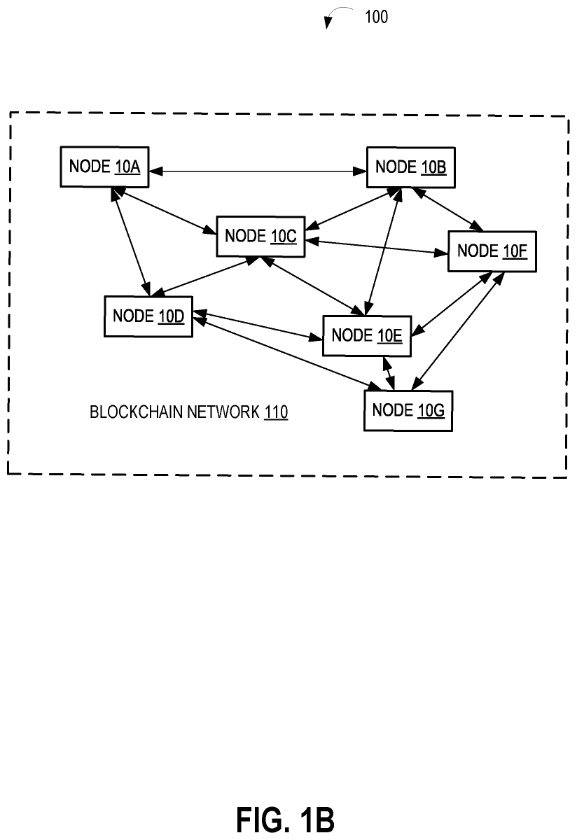

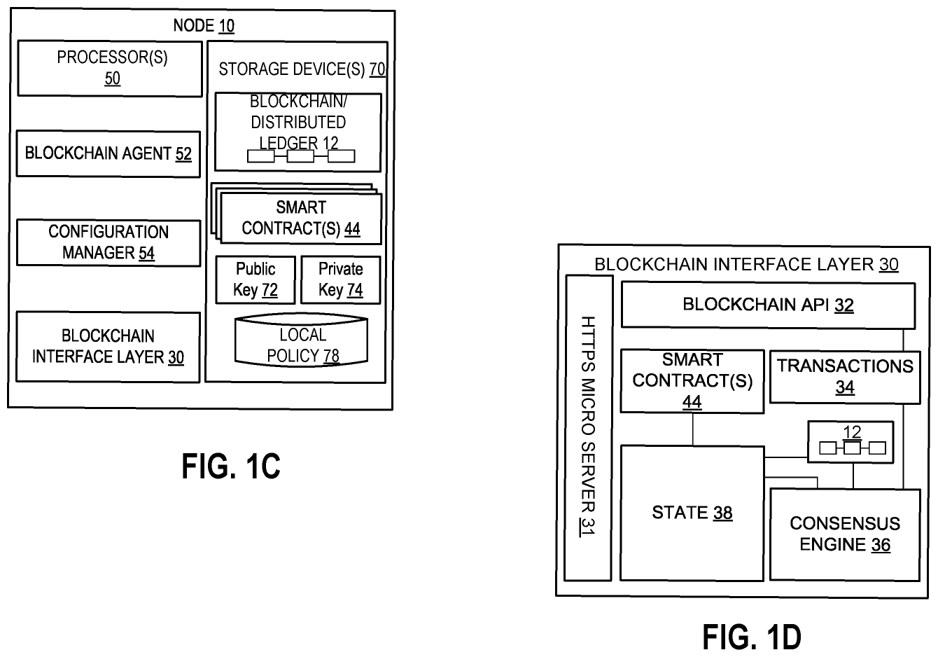

Referring to FIG. 1A, a network 10 is illustrated as comprising a plurality of silos 10A, 10B, and 10C. Each silo 10A-10C may be implemented in a cloud environment, e.g., public, private, or hybrid cloud. A public cloud may share publicly available resources/services over, e.g., the Internet, while a private cloud is not shared and may only offer resources/services over a private data network. A hybrid cloud may share services between public and private clouds depending on the purpose of the services. Cloud-based implementations would be understood by those of ordinary skill in the art to refer to being, e.g., remotely hosted on a system/servers in a network (rather than being hosted on local servers/computers) and remotely accessible. Such a cloud-based system allows a system to be accessible from a variety of places, not just where the system is hosted.

Silos 10A, 10B, and 10C may comprise one or more compute or storage (or both) resources, e.g., processors, memory units, etc. used for executing tasks assigned to a particular resource domain made up of such resources. As illustrated in FIG. 1A, each of silos 10A, 10B, and 10C execute or perform tasks belonging to a particular workflow in a distributed manner. For example, a workflow may comprise processing, model training, model deployment, and inference (ML predictions based on product data) tasks, and in this example, each of silos 10A, 10B, and 10C perform some portion of each of these tasks, creating a federated workflow. This particular workflow and its associated tasks is a non-limiting example.

Accordingly, as illustrated in FIG. 1A, data, e.g., from a dataset used to train the ML model can undergo a processing operation 10A-1. Processing operation(s) 10A-1 may comprise any sort or type of processing/pre-processing of raw data into some format understood by the ML model. Processing of data during processing operation(s) 10A-1 may further comprise removing noise from the raw data, removing anomalous raw data values, computing mean values to replace missing values/data from the dataset, and so on. Those of ordinary skill in the art would understood how processing data may be accomplished.

After processing the raw data at processing operation(s) 10A-1, the processed data may be used to train a model at model training operation(s) 10A-2. Model training can entail use or selection/use of an appropriate algorithm, setting algorithm parameters, and inputting the processed data into the appropriate algorithm so that the algorithm can learn. Training of ML models can be performed on/in some platform comprising the appropriate tools/resources required for training. For example, the processed data may comprise a target or target attribute. The algorithm can be some learning/prediction algorithm (e.g., regression algorithms, K-nearest neighbor algorithms, etc.). The learning/prediction algorithm may find patterns in the training data that can be used to map attributes of the input (processed training data) to the target (the answer to be predicted). Those of ordinary skill in the art would understood how training the ML model may be accomplished. As alluded to above, the output of the learning/prediction algorithm is an ML model (parameters that are automatically tuned by ML algorithms) that captures these identified patterns, enabling the ML model to be used to make inferences, i.e., predict/provide answers when “real” (vs training) data is input into the ML model.

Further still, model deployment operation(s) 10A-3 may be performed at silo 10A. Model deployment (also referred to operationalization) can entail implementing an ML model in the desired environment(s), e.g., the deployed environment(s). Typically, ML models are deployed in environments where the ML models have access to any necessary hardware resources, as well as a data source from which data can be obtained. ML models may also be integrated into some process(es), enabling the ML models to be accessible by users, e.g., via some application programming interface or integration into some software used by users, and enabling such users to execute the ML models, as well as retrieve/interpret ML model output, i.e., inference 10A-4.

As noted above, silos 10A, 10B, and 10C may comprise memory and processing/computing components to enable the performance of the above-described operations, e.g., processor 10A-5 and memory 10A-6. Moreover, the same/similar processing operation(s) (10B-1, 10C-1), model training operation(s) (10B-2, 10C-2, model deployment operation(s) (10B-3, 10C-3), and inference operation(s) (10B-4, 10C-4) may be performed at each of the corresponding silos 10B and 10C. In some examples, other steps may be involved, e.g., validation of the ML model output from the trained prediction/learning algorithm, prior to actual ML model deployment.

As also noted above, examples of the technology disclosed herein operate to allow orchestration of ML workflows across multiple silos. Again, ML workflows can comprise a series of related tasks that accomplish some goal across one or more phases of an ML project, e.g., data collection, data pre-processing, building datasets, model training and refinement, validation/evaluation, and operationalization/deployment. As illustrated in FIG. 1A, each silo 10A, 10B, and 10C may send respective state data or information to a distributed ledger/database such as a blockchain, e.g., blockchain 12, effectuated by a blockchain network, described in greater detail below. State as used herein is specific to workflow/task state and may characterize or represent a current state of operation or progress/operational condition, e.g., whether some task of the workflow/the overall workflow is stopped, has started, resulted in an error, whether or not the task was completed, and so on. In some examples, state may be equivalent to a container state. By virtue of publishing the state of each silo 10A, 10B, and 10C to blockchain 12, each silo 10A, 10B, and 10C has access to each other silo's state. Accordingly, any/all tasks associated with an ML workflow, such as the processing (10A-1, 10B-1, 10C-1), model training (10A-2, 10B-2, 10C-2), model deployment (10A-3, 10B-3, 10C-3), and inference tasks (10A-4, 10B-4, 10C-4) illustrated in FIG. 1A may be orchestrated across silos 10A, 10B, and 10C.

For example, it may be desired that deployment of a particular model occur only after that model is locally trained (e.g., at each silo 10A, 10B, and 10C). Accordingly, each silo 10A, 10B, and 10C may publish their respective states indicating completed training, and only thereafter will tasks associated with model deployment be executed (10A-3, 10B-3, and 10C-3). Each silo 10A, 10B, and 10C can obtain, from blockchain 12, states of each other silo to determine when it can begin its model deployment task.

Blockchain 12 as alluded to above, may be effectuated via a blockchain network. The blockchain aspect allows for decentralized control and scalability, while also providing the requisite fault-tolerance to enable examples to work beyond the single entity/resource domain context. Moreover, due to the ability of blockchains to log every transaction, and because transactions are the only mechanism by which to change some global state, a durable audit log is achieved. Such an audit log can be used to build and auditing and compliance framework for workflow execution. Thus, various Although examples are described in the blockchain context, any distributed database or ledger that allows silos to share workflow/task metadata and state information may be used.

A command and control “view” or framework can be provided that allows participant nodes in a network to interact with each other using blockchain technology, where the view is globally consistent (vis-à-vis the blockchain), and reliable actions can be taken as result. It should be understood that such nodes may be embodied by one of more of the silos described herein. That is, silo 10A of FIG. 1A may, for example, comprise a node of a blockchain network, silo 10B of FIG. 1A may comprise another node, and so on. In some examples, multiple nodes may comprise a particular silo depending on the manner in which resources may be partitioned. The use of blockchain technology for federating workflows across resource domains may be implemented to ensure that the interactions, in this case, the storing/publishing of task/workflow state and metadata, are secured, non-repudiated, sequenced and permissioned. For example, one node/silo may be elected to act as a “leader” for purposes of uploading workflow or task state/metadata to blockchain 12. Once a leader is finished interacting with blockchain 12, another node/silo may be elected to act as a leader giving that node/silo an opportunity to store its relevant state/metadata to blockchain 12. In some examples, a node may need to interact with another node, in which case, the node needing to interact with another node may be elected leader, the node may perform its requisite operation(s) or communication(s). That node may subsequently relinquish is elected leader status, and another node needed to perform some operation may be elected leader. In some examples, a node may wish to advertise or broadcast its services/resources on blockchain 12 so other nodes/silos may become aware of available services/resources of which it may avail itself.

In another example, operations may be implemented to provide provenance tracking across a heterogeneous distributed storage platform to track which nodes conducted which operations on which systems. In some applications, metadata operations may be routed via a blockchain and storage devices or other network entities can be configured to accept operations only via the blockchain interface. For example, storage devices on the network can be commanded to allow metadata operations only via the blockchain interface. In this way, factors such as identity, authorization, provenance, non-repudiation and security can be provided for operations on nodes managed in this way.

Each of the nodes may act as a node that stores a complete or at least updated copy of blockchain 12. A node may read its local copy of blockchain 12 to obtain the change requests. Upon receipt of a change request, the node may implement the change request and update its state to indicate the change request has been implemented. This state transition may be broadcast to other nodes, such as in the form of a blockchain transaction.

FIG. 1B illustrates an example of a system 100 of decentralized management of device assets, according to some examples. System 100 may include a blockchain network 110. The blockchain network 110 may include a plurality of nodes that are connected to one another using one or more connection protocols, including a peer-to-peer connection protocol. The particular number of, configuration of, and connections between the nodes 10 may vary, and includes nodes 10A-10G (where nodes 10A, 10B, and 10C may be embodied as silos 10A, 10B, and 10C. As such, the arrangement of nodes 10 shown in FIG. 1B is for illustrative purposes only.

Node 10 of FIG. 1C may be a fixed or mobile device. While only one of the nodes 10 is illustrated in detail in the figures, each of nodes 10 may be configured in the manner illustrated. The nodes 10 may communicate with one another in a peer-to-peer manner. The nodes 10 may each include one or more processor(s) 50, one or more storage devices 70, and/or other components.

The processor(s) 50 may be programmed by one or more computer program instructions. For example, the processor(s) 50 may be programmed to execute a blockchain agent 52, a configuration manager 54, a blockchain interface layer 30, and/or other instructions to perform various operations, each of which are described in greater detail herein. As used herein, for convenience, the various instructions will be described as performing an operation, when, in fact, the various instructions program the processor(s) 50 (and therefore node 10) to perform the operation.

The blockchain agent 52 may use the blockchain interface layer 30 to communicate with other nodes 10. The blockchain interface layer 30 may communicate with the blockchain network 110. For example, the blockchain agent 52 may obtain an updated copy of blockchain 12 from one or more other nodes 10, e.g., state and metadata associated with task/workflow performance by other nodes 10.

The configuration manager 54 may obtain state information regarding the progress of a task, e.g., that model training of a ML model is complete from the blockchain agent 52. The configuration manager 54 may, in accordance with an agent, progress with performing a required subsequent task by node 10. In some instances, the configuration manager 54 may perform an operation without a determination of whether to do so. In other instances, the configuration manager 54 may consult one or more local policies to ensure that node 10 can comply with the one or more operations. The local policies may be encoded by the smart contracts 44. Alternatively or additionally, some local policies may be stored in a local policy 78, which is not necessarily shared with other nodes 10. In other words local policy 78 may be defined specifically at a node at which it is stored.

Blockchain agent 52 may broadcast its state to other nodes of the blockchain network 110. For example, the blockchain agent 52 may generate and transmit a blockchain transaction that indicates the state of node 10 (such as whether, a particular task has been completed). The blockchain transaction may include information identifying whether the task was (or was not) performed. For example, the information identifying the operation may be a block identifier (such as a block hash) that identifies the block from which the management operations was obtained. In this manner, the blockchain transaction indicating a node's state may record the management operation that was (or was not) applied.

In the context of various examples, global state of a workflow is present as a local copy in each node of blockchain network 110. Any of the nodes of blockchain network 110 may initiate an operation to change the global state, and once changed, the remaining/other nodes will obtain/become aware of that global state change once that change of global state request is recorded in the distributed ledger 42, i.e., a block approved by blockchain network 110. Once such a block containing the global state change transaction is received by a node, that node will update its copy of the distributed ledger 42 commensurate with the change. Once all the nodes have updated their respective copies of distributed ledger 42, the global state change may be considered to have been effectuated.

The storage devices 70 may store a node's copy of the distributed ledger 42, the node's copy of smart contracts 44, the node's public key 72, the node's private key 74, and/or other data.

The smart contracts 44 may include rules that configure nodes to behave in certain ways in relation to federated ML workflow orchestration. For example, the rules may specify deterministic state transitions, which nodes may undergo while performing tasks of a workflow, or other actions that a node may take for federated workflow orchestration. In some embodiments, such rules may specify when to elect a lead node/leader, for example.

The node keys 46 may store public encryption keys of nodes 10 in association with their identities (such as Internet Protocol or other addresses and/or identifying information). In this manner, in some implementations, change requests may be targeted to specific nodes 10 and encrypted using a target node's public key.

Reference will now be made to FIG. 1D, which illustrates an example of the blockchain interface layer 30. Each of the nodes 10 may implement the blockchain interface layer 30. The blockchain interface layer 30 may include a messaging interface used to communicate with the blockchain network 110. The messaging interface may be configured as a Secure Hypertext Transmission Protocol (“HTTPS”) microserver 31. Other types of messaging interfaces may be used as well. The blockchain interface layer 30 may use a blockchain API 32 to make calls for blockchain functions based on a blockchain specification. Examples of blockchain functions include, but are not limited to, reading and writing blockchain transactions 34 and reading and writing blockchain blocks to blockchain 12. One example of a blockchain specification is the Ethereum specification. Other blockchain specifications may be used as well. Consensus engine 36 may include functions that make consensus decisions, such as whether to enroll a node to participate in a federated ML workflow. The state of a node 10 can be reflected by state 38.

Although illustrated in FIG. 1C as a single component, a node 10 may include a plurality of individual components (such as computer devices) each programmed with at least some of the functions described herein. The one or more processor(s) 50 may each include one or more physical processors that are programmed by computer program instructions. The various instructions described herein are provided for illustrative purposes. Other configurations and numbers of instructions may be used, so long as the processor(s) 50 are programmed to perform the functions described herein.

Furthermore, it should be appreciated that although the various functions are illustrated in FIG. 1C as being co-located within a single processing unit, in implementations in which processor(s) 50 includes multiple processing units, one or more instructions may be executed remotely from the other instructions.

The various instructions for performing functions described herein may be stored in a storage device 70, which may comprise random access memory (RAM), read only memory (ROM), and/or other memory. Storage device 70 may store the computer program instructions (such as the aforementioned instructions) to be executed by processor(s) 50, respectively, as well as data that may be manipulated by processor(s) 50. Storage device 70 may comprise one or more non-transitory machine-readable storage media such as floppy disks, hard disks, optical disks, tapes, or other physical storage media for storing computer-executable instructions and/or data.

The blockchain 12, transaction queue, smart contracts 44, operations to be performed, and/or other information described herein may be stored in various storage devices such as storage device 70. Other storage may be used as well, depending on the particular storage and retrieval requirements. For example, the various information described herein may be stored using one or more databases, locally. In some examples, these database instances need not be shared. Use of distributed ledger 42 as a common resource/repository for the entire federated framework is sufficient. The databases may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

The nodes 10 illustrated in FIG. 1C may be coupled to other nodes via a network, which may include any one or more of, for instance, the Internet, an intranet, a PAN (Personal Area Network), a LAN (Local Area Network), a WAN (Wide Area Network), a SAN (Storage Area Network), a VPN (Virtual Private Network), a MAN (Metropolitan Area Network), a wireless network, a cellular communications network, a Public Switched Telephone Network, and/or other network. Furthermore, according to various implementations, the components described herein may be implemented in hardware and/or software that configure hardware.

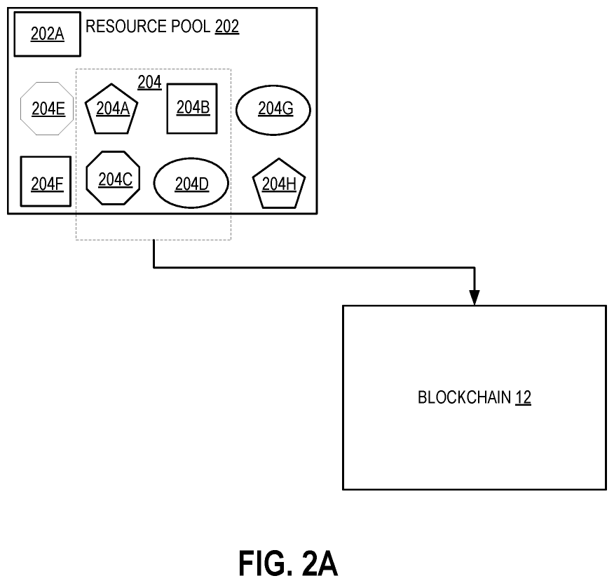

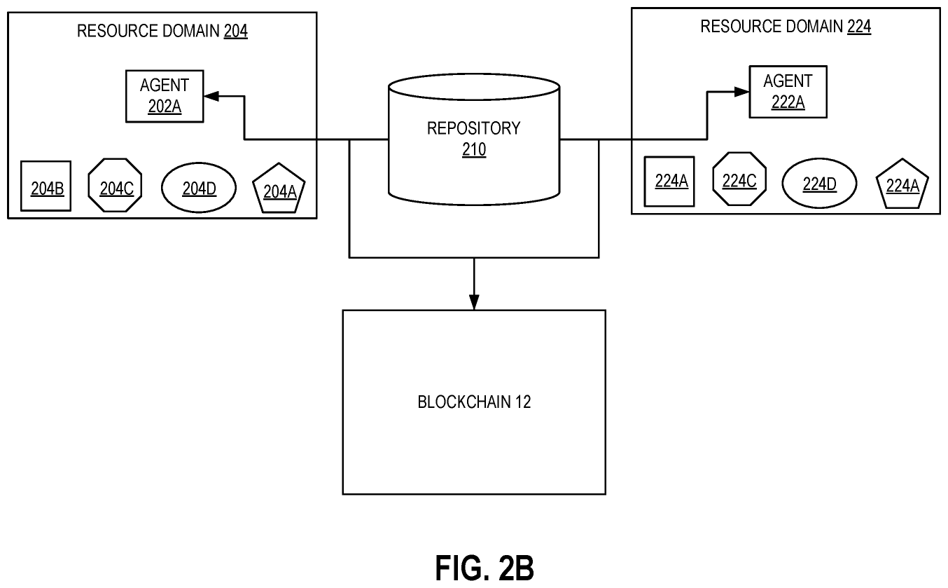

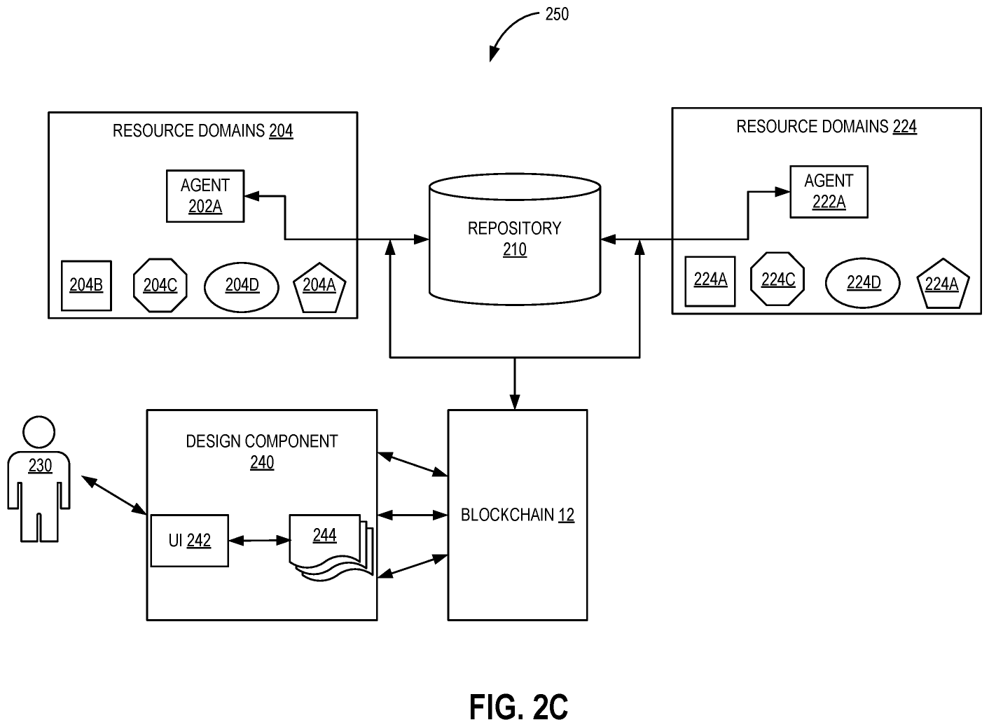

FIG. 2A illustrates an example of resource partitioning applied to examples of the technology disclosed herein. Partitioning may be accomplished in relation to a pool of resources 202 within a silo/node or a cluster of silos/nodes. Such resources may comprise compute 204A, storage 204B, networking 204C, and security 204D resources, e.g., processors, memory, network cards, firewalls, and so on, out of a plurality of resources. Other resources may not be included in the partition/domain, e.g., resources 204E, 204F, 204G, 204H). Such resources 204A-D may be controlled by a native resource manager 202A, such as a K8s manager, Rancher Docker, etc. for managing or provisioning resources locally on physical node hardware. In a centralized system/framework, a master exists which has knowledge regarding the characteristics of those resources under its control. For example, another entity may query the master as to what resources are available for use, how much storage is available, and so on. In contrast, such characteristics may be stored as metadata in a distributed ledger, such as blockchain 12, in accordance with some examples of the technology disclosed herein. Thus, unlike a centralized system that relies on querying a central controller/master, any node that is authorized to view/use blockchain 12 may see what resources are available, what characteristics those resources may have, etc., by simply accessing blockchain 12 for such information.

FIG. 2B illustrates example resource domain usage in accordance with examples of the technology disclosed herein. As illustrated in FIG. 2B, a first resource domain 204 and a second resource domain 224 may comprise respective resources partitioned from resource pools to be used to execute tasks of a workflow. As previously discussed, each resource domain may be associated with an agent, in this example, agent 202A associated with resource domain 204, and agent 22A associated with resource domain 224. Resource domain 204 may include resources 204A-D, which, as also previously discussed, may be compute resources, memory resources, or both. Likewise, resource domain 224 may include resources 224A-D, which again may be compute resources, memory resources, or both.

In orchestrating a workflow, each agent 202A and 222A may be assigned or delegated tasks (from repository 210) to be performed by the respective resource domains managed by each of agents 202A and 222A. Agents 202A and 222A may abstract the resources under its control to allow the obtained tasks to be executed eliminating the issue of resource heterogeneity. That is, agents allow a genericized task encapsulated in a container to be performed by the local resource(s) of the resource domain by abstracting resource characteristics like access, authentication, etc. in such a way that the tasks can access/use the local resources without needing to use specific commands, access particular to the kind/type of resource. Agents may “expose” a resource domain in which agents execute assigned tasks. Agents 202A and 222A may each maintain their respective workflow/task states, which, as also discussed above, can be published to a distributed database or ledger, such as blockchain 12.

Without a centralized controller, agents 202A and 222A may interact, communicate, coordinate with another through blockchain 12. Agents 202A and 222A may interact/communicate with one another using control messaging on blockchain 12. Agents 202A and 222A maintain awareness of each other's workflow/task state via blockchain 12. As discussed above, use of blockchain 12, and a leader election mechanism allows a particular agent to perform needed operations/actions. For example, if agent 202A deems it necessary (by virtue of executing a task) to access and obtain data stored in a memory resource 224D of resource domain 224, agent 202A may seek to become elected an acting leader. Agent 202A may determine a current/latest state of resource domain 224 from blockchain 12. Agent 202A may determine that resource domain 224 has not yet completed a current task, and cannot be accessed until completion of that task. Upon completion of that task (agent 202A monitors blockchain 12 until it becomes aware that resource domain 224's state equates to completion of its current task), agent 202A may seek to get elected as an acting leader, allowing it to access memory resource 224D to obtain the requisite data therefrom. After agent 202A completes its task, it may relinquish its position as acting leader.

As discussed above, silos or resource domains, such as resource domains 204 and 224, may be embodied on/as nodes of a blockchain network, and nodes may undergo an election process to select one of the nodes to act as an acting leader. Election votes are recorded in blockchain 12, which again, can reflect a record of a node's state as well as its identity, so votes can be associated with the nodes submitting those votes, and a node selected, in this example, to be an acting leader can be made aware of its state/elected role. In some embodiments, each node uses agreed-upon voting/election logic, the winner of which is elected as the acting leader. For example, each node may randomly select a number that it registers in blockchain 12, and the node registering the lowest number (or highest number, or closest to a defined number, etc.) can be used as a basis for election. Those having ordinary skill in the art would be aware of different election mechanism that can be implemented in this context. Once votes are recorded in blockchain 12, each of the nodes, in this case resource domains 204 and 224, each query blockchain 12 to determine if it has been selected to be the acting leader. In the meantime, each of the other nodes, in this case, resource domain 224 enter into a wait state. One example of a blockchain-based election system is described in co-pending U.S. Publication No. 2021/0394017, which is incorporated herein by reference in its entirety.

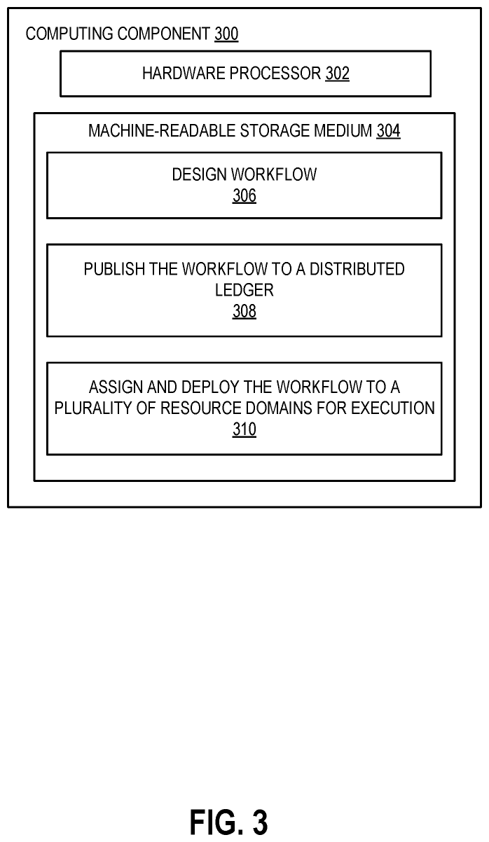

FIG. 2C illustrates an example of a federated ML workflow framework or architecture 250, and will be described in conjunction with FIG. 3, an example computing component 300 that may be used to implement various features of federated ML workflow orchestration in accordance with an embodiment of the disclosed technology.

Computing component 300 may be, for example, a server computer, a controller, or any other similar computing component capable of processing data. In the example implementation of FIG. 3, the computing component 300 includes a hardware processor 302, and machine-readable storage medium 304. In some embodiments, computing component 300 may be an embodiment of any processors, controllers, and similar components described herein, or may be used to realize the functionality of various components, e.g., design component 240.

Hardware processor 302 may be one or more central processing units (CPUs), semiconductor-based microprocessors, and/or other hardware devices suitable for retrieval and execution of instructions stored in machine-readable storage medium 304. Hardware processor 302 may fetch, decode, and execute instructions, such as instructions 306-312, to control processes or operations for merging local parameters to effectuate federated learning in a blockchain context using homomorphic encryption. As an alternative or in addition to retrieving and executing instructions, hardware processor 302 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 304, may be any electronic, magnetic, optical, or other physical storage device that contains or stores executable instructions. Thus, machine-readable storage medium 304 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 304 may be a non-transitory storage medium, where the term “non-transitory” does not encompass transitory propagating signals. As described in detail below, machine-readable storage medium 304 may be encoded with executable instructions, for example, instructions 306-312.

Hardware processor 302 may execute instruction 306 to design a workflow. Referring back to FIG. 2C, a user 230, e.g., a system administrator or ML scientist, may design or construct an ML workflow (or other workflows) using a design component 240. Design component 240 may include a user interface (UI) 242 as well as a cache of metadata from blockchain 12. UI 242, as will be described below, can provide user insight into a federated ML workflow, as well as present user 230 with a manipulatable view of a workflow's/task's state, and task metadata with which to design a federated ML workflow. Design component 240 can support multiple, concurrent designers. Users, such as user 230 may provide user input to design component 240/UI 242. Such user input(s) may include any information, data, parameters, instructions, etc. that may be specified by a user and related to the design of an ML workflow, e.g., task selection, instructions/commands regarding task/workflow orchestration, and the like (as will be described below).

As noted above, tasks/containers that can be used to make up an ML workflow may be associated with certain metadata characterizing the nature of the task, e.g., a tasks requisite input, its output, dependencies, constraints, communication mechanisms/channels, and so on. User 230 may construct an ML workflow using tasks that can be discovered using cached metadata 244 via UI 242 in design component 240. For example, a user wishing to accomplish some goal using ML may need to orchestrate the execution of certain tasks. Tasks/containers having characteristics meeting the requirements/needs of those certain tasks can be discovered by the user 230, who may then chain or create some desired sequence of tasks to be performed. In some examples, creation of an ML workflow may be in accordance with graph theory, i.e., using vertices/nodes and arcs (between the vertices/nodes) to represent/deal with problems having a graph/network structure. Given that the resource domains used in an ML workflow, in this example resource domains 204A and 224A, are embodied as/by blockchain nodes (FIG. 1B), ML workflow design based on a property graph model is an appropriate method of design for orchestrating the performance of tasks between multiple, federated resource domains/nodes, although other design schema may be used. A property graph has relationships with metadata of the tasks and their associated relationships as properties. Hence, metadata can be easily/quickly accessed, and tasks and related metadata can be effectively re-used as needed. That is, design component 240, can define or construct an ML workflow based on tasks selected by a user, and a designated orchestration regarding performance of those tasks.

Hardware processor 302 may execute instruction 308 to publish the workflow to a distributed ledger. That is, once constructed, design component 240 may be used to publish the constructed workflow onto blockchain 12. By publishing the federated ML workflow onto blockchain 12, all participating resource domains (204 and 224) can be made aware of the federated ML workflow in which the participating resource domains will be used.

Hardware processor 302 may execute instruction 310 to assign and deploy the workflow to a plurality of resource domains for execution. Design component 240 may be used by user 230 to assign the workflow to federated silos, in this example resource domains 204 and 224. Assigning the workflow may involve orchestrating the performance of certain tasks on certain resource domains to achieve the desired result the workflow is intended to provide across multiple silos. Design component 240 may also be used by user 230 to deploy a constructed workflow into federated ML workflow framework 250. That is, once assigned, resource domains 204 and 224 may obtain their respective (containerized) tasks from repository 210, and commence with executing those tasks. It should be noted that design component 240 may also monitor the workflow, e.g., progress during execution, state, and so on.

Thus, design component 240 may provide user 230 with a one-stop interface into the federated ML workflow framework 250 and execution of the federated ML workflow therein. Once assigned to resource domains 204 and 224, agents 202A and 222A may execute the requisite tasks on each of the respective resource domains 204 and 224, and report their respective states to blockchain 12. State reporting can be performed in response to events, e.g., event-driven reporting (such as when state changes) in addition to periodic updating during wait periods/states. Periodic updates are performed so that node status (alive, operational, non-operational, etc.) can be obtained/shared.

Various examples of the disclosed technology are able to achieve federated ML workflows in spite of typically heterogenous system infrastructures/platforms. Different silos, entities, resource domains may easily collaborate due to fully decentralized control based on blockchains and a blockchain-implemented election schema. Because workflow and task state from each silo or resource domain are published to a blockchain, the federated ML workflow framework may be considered to be fault-tolerant, as well as self-healing. That is, because examples of the disclosed technologies depend on consensus and voting, node faults can be tolerated so long as the minimum quorum of nodes needed to perform operations is present. In other words, a single node fault, for example, will not jeopardize the other nodes. In terms of self-healing, because, as noted above, blockchains or similar distributed databases have an auditable log of transactions (that in this context reflect state changes), if/when a node becomes non-operational, the node, upon becoming operational again, may access the log, and update itself to a current operating state (of the system) without external intervention. Further still, there is a desirable characteristic of federated ML workflow orchestration, i.e., openness, due to the logging or recording of control operations and metadata in the blockchain. The local autonomy of nodes is also preserved by the integration of node-specific agents that execute tasks locally in accordance with a local policy engine, and seamless scaling can be realized due to the use of resource domains and a state/metadata-preserving blockchain.

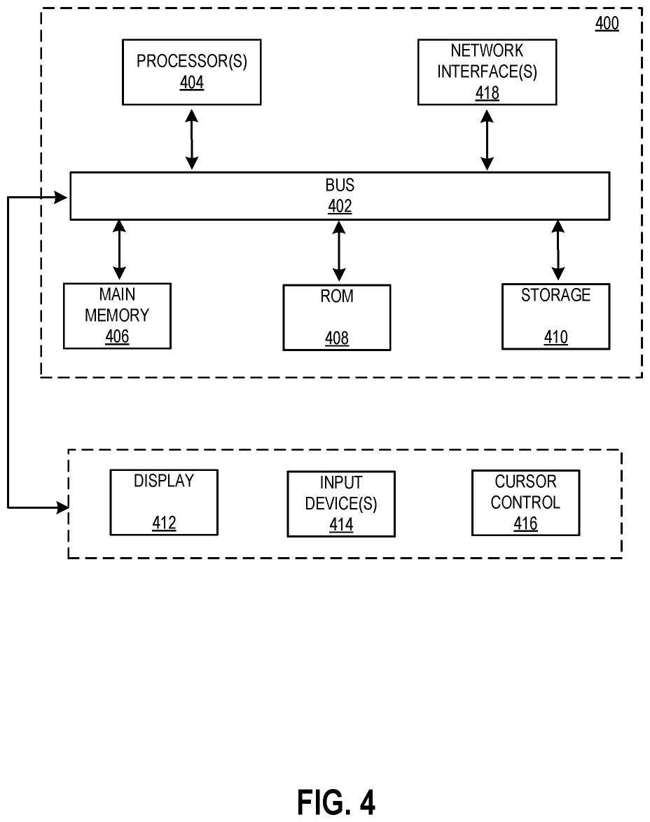

FIG. 4 depicts a block diagram of an example computer system 400 in which various embodiments described herein may be implemented. The computer system 400 includes a bus 402 or other communication mechanism for communicating information, one or more hardware processors 404 coupled with bus 402 for processing information. Hardware processor(s) 404 may be, for example, one or more general purpose microprocessors. In some embodiments, computer system 400 may be an embodiment of any processors, controllers, and similar components described herein, e.g., processor 10A-5, processor 50, or may be used to realize the functionality of various components.

The computer system 400 also includes a main memory 406, such as a random access memory (RAM), cache and/or other dynamic storage devices, coupled to bus 402 for storing information and instructions to be executed by processor 404. Main memory 406 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions.

The computer system 400 further includes a read only memory (ROM) 408 or other static storage device coupled to bus 402 for storing static information and instructions for processor 404. A storage device 410, such as a magnetic disk, optical disk, or USB thumb drive (Flash drive), etc., is provided and coupled to bus 402 for storing information and instructions.

The computer system 400 may be coupled via bus 402 to a display 412, such as a liquid crystal display (LCD) (or touch screen), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. In some embodiments, the same direction information and command selections as cursor control may be implemented via receiving touches on a touch screen without a cursor.

The computing system 400 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor(s) 404 executing one or more sequences of one or more instructions contained in main memory 406. Such instructions may be read into main memory 406 from another storage medium, such as storage device 410. Execution of the sequences of instructions contained in main memory 406 causes processor(s) 404 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 410. Volatile media includes dynamic memory, such as main memory 406. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 402. Transmission media can also take the form of acoustic or light waves, such as those generated during radio-wave and infra-red data communications.

The computer system 400 also includes a communication interface 418 coupled to bus 402. Network interface 418 provides a two-way data communication coupling to one or more network links that are connected to one or more local networks. For example, communication interface 418 may be an integrated services digital network (ISDN) card, cable modem, satellite modem, or a modem to provide a data communication connection to a corresponding type of telephone line. As another example, network interface 418 may be a local area network (LAN) card to provide a data communication connection to a compatible LAN (or WAN component to communicate with a WAN). Wireless links may also be implemented. In any such implementation, network interface 418 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 418, which carry the digital data to and from computer system 400, are example forms of transmission media.

The computer system 400 can send messages and receive data, including program code, through the network(s), network link and communication interface 418. In the Internet example, a server might transmit a requested code for an application program through the Internet, the ISP, the local network and the communication interface 418.

The received code may be executed by processor 404 as it is received, and/or stored in storage device 410, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
designing a machine learning (ML) workflow based on user inputs specifying tasks making up the ML workflow;
publishing the ML workflow to a distributed ledger accessible by the plurality of federated resource domains; and
assigning and deploying the ML workflow to one or more resource domains of the plurality of federated resource domains.

2. The method of claim 1, wherein each of the specified tasks comprises a task body and task metadata.

3. The method of claim 2, wherein the specifying of the tasks is based on the task metadata characterizing a nature of each task, the task metadata being maintained in the distributed ledger, and being presented via a user interface to a user providing the user inputs.

4. The method of claim 2, wherein each of the specified tasks is containerized.

5. The method of claim 1, wherein each federated resource domain of the plurality of federated resource domains comprises a siloed resource partition including at least one of compute, storage, networking, and security components capable of performing one or more of the specified tasks.

6. The method of claim 5, wherein at least two of the siloed resource partitions comprise heterogeneous implementations of the at least one of the compute, storage, networking, and security components.

7. The method of claim 5, wherein each federated resource domain comprises an execution agent orchestrating performance of the specified tasks at each federated resource domain.

8. The method of claim 1, wherein the distributed ledger comprises a blockchain.

9. The method of claim 8, wherein each federated resource domain of the plurality of federated resource domains comprises one or more nodes of a blockchain network maintaining local copies of the blockchain.

10. The method of claim 9, further comprising publishing a state of the ML workflow to the distributed ledger pursuant to performance of an action changing the state of the ML workflow.

11. A system, comprising:
a processor; and
a memory including instructions that when executed, cause the processor to:
present, from a metadata cache, a plurality of tasks to a user of the system, characteristics of each of the plurality of tasks being represented by associated metadata;
in accordance with a set of tasks selected by the user from the plurality of tasks, define a workflow comprising the selected set of tasks;
publish the workflow to a distributed ledger;
assign and deploy the workflow to a plurality of resource domains; and
monitor execution of the workflow via workflow state information published by each of the resource domains to the distributed ledger.

12. The system of claim 11, wherein the metadata cache is derived from the associated metadata, the associated metadata being stored in the distributed ledger.

13. The system of claim 11, wherein each of the resource domains comprises one or more edge nodes of a network, the one or more edge nodes defining a blockchain network, each of the one or more edge nodes comprising a local copy of the distributed ledger.

14. The system of claim 11, wherein at least two resource domains of the plurality of resource domains comprise disparate resource creating a heterogeneous plurality of resource domains.

15. The system of claim 14, wherein each of the plurality of tasks comprises a representative container generically defining the characteristics of each of the plurality of tasks allowing each of the plurality of tasks to be performed by the heterogeneous plurality of resource domains

16. The system of claim 15, wherein each of the plurality of tasks comprises a representative container generically defining the characteristics of each of the plurality of tasks.

17. A system, comprising:
a processor; and
a memory including instructions that when executed, cause the processor to:
obtain a federated workflow from a distributed ledger, the federated workflow comprising a plurality of tasks whose characteristics are represented by metadata associated with each of the plurality of tasks, the metadata also being stored in the distributed ledger;
orchestrate federated execution of one or more tasks of the plurality of tasks;
execute the one or more tasks of the plurality of tasks; and
publish a current state of the workflow corresponding to a current operational condition of the workflow from the system's perspective to the distributed ledger.

18. The system of claim 17, comprising a resource domain operative in a network comprising a plurality of resource domains facilitating the federated execution of the one or more tasks of the plurality of tasks.

19. The system of claim 18, wherein the resource domain comprises one or more nodes of a blockchain network, each of the one or more nodes including a local version of the distributed ledger.

20. The system of claim 19, wherein the memory includes instructions that when executed, further cause the processor to at least one of update the local version of the distributed ledger and obtain an updated version of the distributed ledger associated with at least one other resource domain of the plurality of resource domains.
